(19) United States
(12) Patent Application Publication
(10) Pub. No.: US 2026/0323129 A1
(43) Pub. Date: Oct. 15, 2026

(54) CONTENT PRESENTATION METHOD AND APPARATUS, AND DEVICE AND STORAGE MEDIUM

(71) Applicant: Beijing Zitiao Network Technology Co., Ltd., Beijing (CN)

(72) Inventor: Zijun Zhou, Beijing (CN)

(21) Appl. No.: 19/120,108

(22) PCT Filed: Oct. 10, 2023
(86) PCT No.: PCT/CN2023/123752

§ 371 Date: Apr. 10, 2025

(30) Foreign Application Priority Data
Oct. 10, 2022 (CN) 202211234035.2

(51) Int. Cl. H04N 21/4788; H04N 21/2187; H04N 21/431

(52) U.S. Cl. CPC H04N 21/4788; H04N 21/2187; H04N 21/4316

(57) ABSTRACT

A content presentation method, apparatus, device and storage medium. The content presentation method comprises: displaying a first interface in a first display mode, and presenting first media content in a first manner in the first interface, wherein the first interface is used to present shared media content in a shared media stream, and the shared media stream includes a media stream corresponding to a shared interaction performed between a first user and at least one second user; determining that the current display mode of the first interface is a second display mode, wherein the second display mode is different from the first display mode; and presenting the first media content in a second manner in the first interface, wherein the second manner is different from the first manner.

### CROSS REFERENCE TO RELATED APPLICATIONS

This application claims the priority of the Chinese patent application filed with the China Patent Office on Oct. 10, 2022, with application number 202211234035.2, the content of which is incorporated herein by reference in its entirety.

### FIELD

The present disclosure relates to the field of computer technology, for example, to a content presentation method, apparatus, device and storage medium.

### BACKGROUND

With the rapid development of Internet technology and terminal technology, interaction between users is becoming more and more convenient. Multiple users can share the same media stream content, thereby realizing shared interaction based on shared media stream.

### SUMMARY

The present disclosure provides a content presentation method, apparatus, storage medium and device.

In a first aspect, the present disclosure provides a content presentation method, comprising:
displaying a first interface in a first display mode, and presenting first media content in a first manner in the first interface, wherein the first interface is used to present shared media content in a shared media stream, and the shared media stream includes a media stream corresponding to a shared interaction performed between a first user and at least one second user;
determining that the current display mode of the first interface is a second display mode, wherein the second display mode is different from the first display mode;
displaying the first media content in a second manner in the first interface, wherein the second manner is different from the first manner.

In a second aspect, the present disclosure further provides a content presentation device, comprising:
a first presentation module, configured to display a first interface in a first display mode, and to display first media content in a first manner in the first interface, wherein the first interface is used to present shared media content in a shared media stream, and the shared media stream includes a media stream corresponding to a shared interaction performed between a first user and at least one second user;

a display mode determination module, configured to determine that the current display mode of the first interface is a second display mode, wherein the second display mode is different from the first display mode;
a second presentation module, configured to present the first media content in a second manner in the first interface, wherein the second manner is different from the first manner.

In a third aspect, the present disclosure further provides an electronic device, the electronic device including:
one or more processors;
a storage apparatus, configured to store one or more programs;
wherein the one or more programs, when executed by the one or more processors, cause the one or more processors implement the above-mentioned content presentation method.

In a fourth aspect, the present disclosure further provides a storage medium containing computer executable instructions, wherein the computer executable instructions are used to execute the above-mentioned content presentation method when executed by a computer processor.

In a fifth aspect, the present disclosure further provides a computer program product, including a computer program carried on a non-transitory computer-readable medium, wherein the computer program contains program codes for executing the above-mentioned content presentation method.

### BRIEF DESCRIPTION OF THE DRAWINGS

FIG. 1 is a scenario architecture diagram of an application scenario to which a content presentation method provided by an embodiment of the present disclosure is applicable;

FIG. 2 is a flow chart of a content presentation method provided by an embodiment of the present disclosure;

FIG. 3 is a schematic diagram of an interface interaction provided by an embodiment of the present disclosure;

FIG. 4 is another schematic diagram of an interface interaction provided by an embodiment of the present disclosure;

FIG. 5 is another schematic diagram of an interface interaction provided by an embodiment of the present disclosure;

FIG. 6 is another schematic diagram of an interface interaction provided by an embodiment of the present disclosure;

FIG. 7 is another schematic diagram of an interface interaction provided by an embodiment of the present disclosure;

FIG. 8 is a flow chart of another content presentation method provided by an embodiment of the present disclosure;

FIG. 9 is another schematic diagram of an interface interaction provided by an embodiment of the present disclosure;

FIG. 10 is a structural diagram of a content presentation apparatus provided by an embodiment of the present disclosure;

FIG. 11 is a structural diagram of an electronic device provided by an embodiment of the present disclosure.

### DETAILED DESCRIPTION OF EMBODIMENTS

The following will describe embodiments of the present disclosure with reference to the accompanying drawings. Although some embodiments of the present disclosure are shown in the accompanying drawings, the present disclosure can be implemented in various forms, and these embodiments are provided for understanding the present disclosure. The drawings and embodiments of the present disclosure are for exemplary purposes only.

The multiple steps described in the method implementation of the present disclosure can be performed in different orders and/or in parallel. In addition, the method implementation may include additional steps and/or omit the steps shown. The scope of the present disclosure is not limited in this respect.

The term “including” and its variations used herein are open inclusions, i.e., “including”. The term “based on” means “based at least in part”. The term “one embodiment” means “at least one embodiment”; the term “another embodiment” means “at least one other embodiment”; the term “some embodiments” means “at least some embodiments”. The relevant definitions of other terms will be given in the following description.

The concepts of “first”, “second”, etc. mentioned in the present disclosure are only used to distinguish different devices, modules or units, and are not used to limit the order or interdependence of the functions performed by these devices, modules or units.

The modifications of “one” and “multiple” mentioned in the present disclosure are illustrative rather than restrictive. Those skilled in the art should understand that, unless otherwise clearly indicated in the context, they should be understood as “one or more”.

The names of the messages or information exchanged between the multiple devices in the embodiments of the present disclosure are only for illustrative purposes, and are not used to limit the scope of these messages or information.

Before using the technical solutions disclosed in the embodiments of the present disclosure, the types, scope of use, and usage scenarios of the personal information involved in the present disclosure should be informed to the user and the user's authorization should be obtained in an appropriate manner in accordance with relevant laws and regulations.

For example, in response to receiving an active request from the user, a prompt message is sent to the user to clearly prompt the user that the operation requested to be performed will require the acquisition and use of the user's personal information. Thus, the user can autonomously choose whether to provide personal information to software or hardware such as an electronic device, application, server or storage medium that performs the operation of the technical solution of the present disclosure according to the prompt message.

As an implementation, in response to receiving an active request from the user, the method of sending the prompt message to the user can be, for example, a pop-up window, and the prompt message can be presented in text in the pop-up window. In addition, the pop-up window can also carry a selection control for the user to choose “agree” or “disagree” to provide personal information to the electronic device.

The above process of notifying and obtaining user authorization is only illustrative and do not limit the implementation of the present disclosure. Other methods that meet relevant laws and regulations may also be applied to the implementation of the present disclosure.

The data involved in this technical solution (including the data itself, the acquisition or use of the data) shall comply with the requirements of relevant laws and regulations and relevant provisions.

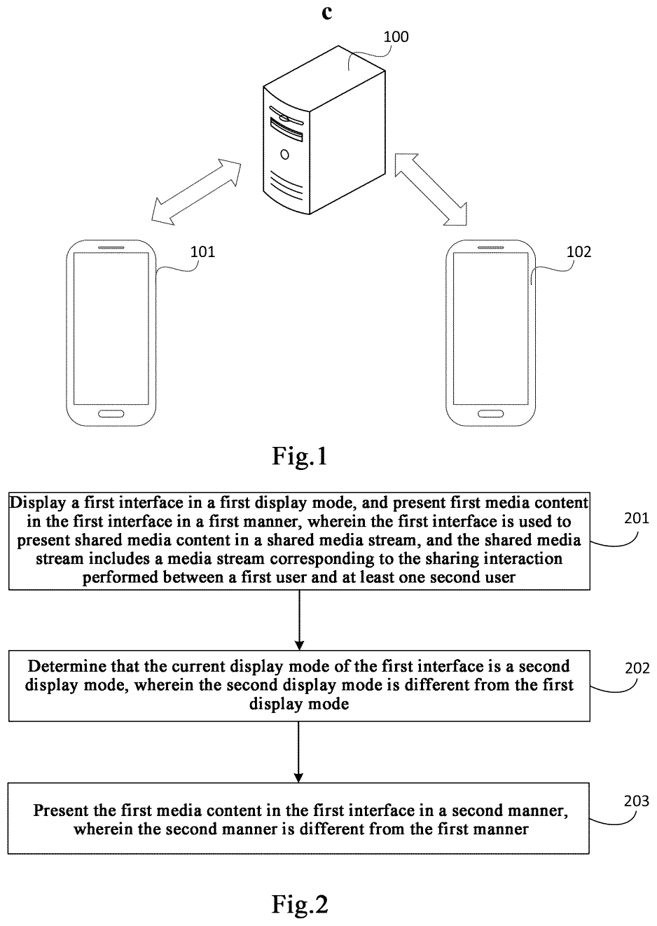

FIG. 1 is a scene architecture diagram of an application scenario to which a content presentation method provided by an embodiment of the present disclosure is applicable. Referring to FIG. 1, the application scenario may include a server 100, a first electronic device 101, and a second electronic device 102. The number of electronic devices can be more, and the number of electronic devices is not limited. FIG. 1 is only a schematic illustration. Multiple electronic devices establish a communication connection with the server to achieve information interaction. The electronic device may be a mobile device such as a mobile phone, a smart watch, a tablet computer, and a personal digital assistant; it may also be other devices such as a desktop computer. Users of electronic devices can make real-time calls, share content, and interact with messages through preset applications installed on the electronic devices. Content sharing may include media stream sharing (hereinafter referred to as shared interaction). Among them, the server can provide support for preset applications. Exemplarily, when multiple users are having a shared interaction, each user can control the shared media stream, such as switching videos. In the embodiment of the present disclosure, the type of the preset application is not limited, for example, it can be a video application, a live broadcast application or an information application, etc., or other types of applications.

FIG. 2 is a flow chart of a content presentation method provided by the embodiment of the present disclosure. The embodiment of the present disclosure is applicable to the situation of content presentation. The method can be executed by a content presentation apparatus, which can be implemented in the form of software and/or hardware, for example, by an electronic device, which can be an electronic device used by any user participating in the shared interaction.

As shown in FIG. 2, the method comprises:

Step 201, display a first interface in a first display mode, and present first media content in the first interface in a first manner, wherein the first interface is used to present shared media content in a shared media stream, and the shared media stream includes a media stream corresponding to the shared interaction performed between a first user and at least one second user.

In the disclosed embodiment, two or more users can be supported to share media streams in real time. The first user is the user currently using the preset application, that is, the local user. It can be understood that the account currently logged in in the preset application is the account of the first user. The second user can be a user who participates in the same media stream sharing with the first user, that is, the opposite user. The number of second users can be one or more, and the number of second users is not limited. The first interface can be a interface in the preset application for presenting the shared media content in the shared media stream. For each user participating in the shared interaction, the shared media stream can be viewed through the electronic device used by the user. Among them, the source of the shared media stream is not limited, and the shared media content contained in the shared media stream can include images, graphics, or videos.

In the disclosed embodiment, the first interface can have multiple display modes, and the display mode can be divided according to the interface form, for example, it can include a horizontal display mode, a vertical display mode, or a floating display mode. Exemplarily, the horizontal display mode can be a horizontal maximized display mode. In this mode, the first interface can occupy the display interface of the preset application. If the preset application is in full-screen operation in the electronic device, the first interface can occupy the screen of the electronic device. Among them, when the first interface is in the horizontal display mode, the width of the first interface is greater than the height of the first interface. The display mode can also be divided according to the type of shared media content presented by the first interface. For example, for image content, it can include a single display mode and a multiple display mode; for graphic content, it can include a text and image mixed layout mode and text and image separation mode; for video content, such as live streaming, it can include a bullet comment display mode and a non-bullet comment display mode. The display mode can also be divided according to a variety of factors, such as combining the interface form and the type of shared media content. Taking live streaming as an example, it can include a display mode of horizontal bullet comment, a display mode of vertical bullet comment, a display mode of horizontal non-bullet comment, and a display mode of vertical non-bullet comment.

Exemplarily, for different users participating in the same shared interaction, the display mode of the first interface displayed on local end can be independent of each other, that is, the display mode of the first interface displayed on local end can be the same as or different from the display mode of the first interface displayed on other user sides. For example, the display mode of the first interface on the first user side is a horizontal display mode; the display mode of the first interface on the second user side can be a vertical display mode or a horizontal display mode.

In the disclosed embodiment, when the first interface is in different display modes, the way of presenting the shared media content may be different, and the difference may be reflected in, for example, the image direction, font size, and whether to present the associated information, associated controls or associated display areas of the shared media content.

Exemplarily, the first display mode may be the current display mode of the first interface, which may be any of the above display modes, and the first manner may be the presentation manner corresponding to the first display mode. The first media content may be any shared media content that needs to be currently presented in the first interface.

Step 202, determine that the current display mode of the first interface is a second display mode, wherein the second display mode is different from the first display mode.

Exemplarily, the display mode of the first interface may support switching, and the display mode may be detected at a preset frequency or in real time, or a switching event of the display mode may be detected, thereby determining the current display mode of the first interface. Assuming that the current display mode of the first interface is determined to be a second display mode different from the first display mode, it can be determined that the current display mode of the first interface has changed.

Step 203, present the first media content in the first interface in a second manner, wherein the second manner is different from the first manner.

Exemplarily, after determining that the current display mode of the first interface is changed from the first display mode to the second display mode, the presentation manner of the first media content needs to be changed accordingly, and displaying the first media content in a first manner in the first interface is changed to displaying the first media content in a second manner different from the first manner.

Exemplarily, taking the first display mode as the vertical display mode as an example, the first manner is the vertical manner, the second display mode is the horizontal display mode, and the second manner is the horizontal manner.

Exemplarily, the vertical manner can be that the height direction of the image in the first media content is consistent with the height direction of the first interface in the vertical display mode; the horizontal manner can be that the width direction of the image in the first media content is consistent with the width direction of the first interface in the horizontal display mode.

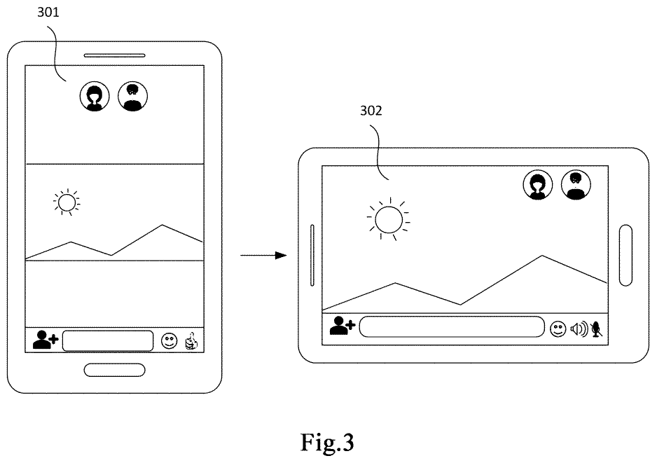

FIG. 3 is a schematic diagram of an interface interaction provided by an embodiment of the present disclosure, the current display mode of the first interface 301 is the vertical display mode, the width of the first interface 301 is less than the height, and in the first interface 301, the first media content in the shared media stream is presented in a vertical manner, such as the landscape video in the figure, and the height direction of the image is consistent with the height direction of the first interface 301, such as the vertical direction in the figure. Subsequently, the display mode of the first interface 301 is changed to the horizontal display mode, as shown in FIG. 3, and the first interface 302 is the first interface whose current display mode is the horizontal display mode after the change, and the width of the first interface 302 is greater than the height. In the first interface 302, the first media content in the shared media stream is presented in a horizontal manner, such as the landscape video in the figure, and the width direction of the image is consistent with the width direction of the first interface 302, such as the horizontal direction in the figure. In the first interface in the horizontal display mode, content related to the shared interaction can also be displayed, such as the user identification of the first user and the second user, such as the user avatar in FIG. 3, and can also include a shared invitation control in the lower left corner, and an expression control, a volume adjustment control, and a microphone control in the lower right corner.

The content presentation method of the disclosed embodiment displays the first interface in the first display mode, and displays the first media content in the first interface in the first manner, wherein the first interface is used to present the shared media content in the shared media stream, and the shared media stream includes a media stream corresponding to the shared interaction performed between the first user and at least one second user, determines that the current display mode of the first interface is the second display mode, and displays the first media content in the first interface in the second manner. By adopting the above technical solution, during the process of the first user and the second user's shared interaction based on the shared media stream, the first interface for presenting the shared media content has the ability to switch the display mode, so that the first user can view the shared media content presented in different ways, enriching the presentation form of the shared media content.

In some embodiments, the second display mode includes a horizontal display mode, and the second manner includes a horizontal manner. Before determining that the current display mode of the first interface is the horizontal display mode, the method further comprises: in response to the horizontal display mode being triggered, switching the current display mode of the first interface from the first display mode to the horizontal display mode. The advantage of this setting is that the switching from the first display mode to the horizontal display mode can be realized.

The first display mode may include modes other than the horizontal display mode, such as the vertical display mode or the floating display mode.

Exemplarily, the horizontal display mode of the first interface can be triggered under the operation of the first user, for example, the horizontal switching control corresponding to the horizontal display mode is displayed, and in response to the first trigger operation input by the first user for the horizontal switching control, the current display mode of the first interface is switched from the first display mode to the horizontal display mode; the horizontal display mode of the first interface can also be automatically triggered when it is detected that a preset horizontal display condition is met, for example, an automatic flip function can be provided in a preset application, and after the first user turns on the automatic flip function, when it is detected that the preset horizontal display condition is met, the first interface is triggered to enter the horizontal display mode. The preset horizontal display condition, for example, can be detecting that the first user holds the electronic device horizontally. The first trigger operation can be, for example, a click operation or a long press operation.

In some embodiments, after the current display mode of the first interface is switched from the first display mode to the horizontal display mode, the method further comprises: in response to the first display mode being triggered, the current display mode of the first interface is switched from the horizontal display mode to the first display mode. Exemplarily, a return control is displayed in the first interface in the horizontal display mode, and it can be switched back to the first display mode after the user click the return control.

In some embodiments, in response to the horizontal display mode being triggered, switching the current display mode of the first interface from the first display mode to the horizontal display mode includes: if the first media content is a preset type of media content, displaying a horizontal switching control corresponding to the horizontal display mode, wherein the preset type of media content supports horizontal presentation; in response to the first trigger operation input by the first user for the horizontal switching control, switching the current display mode of the first interface from the first display mode to the horizontal display mode. The advantage of such a setting is that when the currently presented shared media content supports horizontal presentation, the horizontal switching control can be automatically displayed, so that the user can quickly switch to the horizontal display mode.

The preset type of media content may include horizontal media content, which may be a media content whose display width of the included image is greater than the display height, and the vertical media content may be a media content whose display width of the included image is less than the display height. The preset type of media content may also include media content that supports switching to horizontal media content, wherein the switching method may include adjusting the display ratio of the image, etc. When publishing, the publisher of the shared media content can publish the media content with the same theme in a horizontal version and a vertical version, so that the server side can obtain the corresponding version of the media content for display according to the actual display mode. The horizontal switching control can be, for example, a “full screen play” button or a “horizontal play” button. The first trigger operation can be, for example, a click operation.

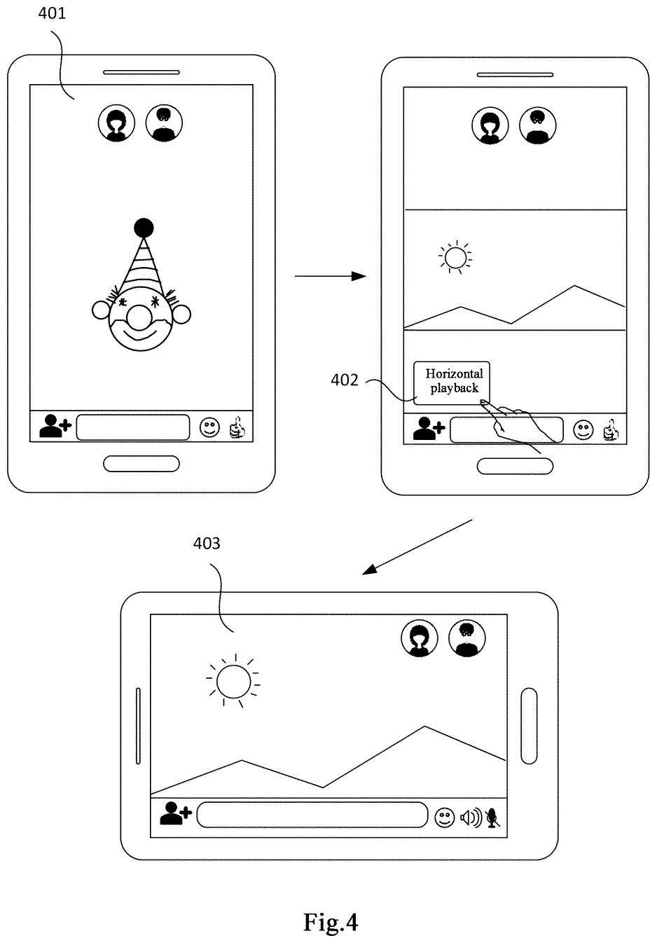

FIG. 4 is another interface interaction schematic diagram provided by an embodiment of the present disclosure. As shown in FIG. 4, assuming that the first display mode includes a vertical display mode, the first interface 401 in the vertical display mode is playing a vertical media content (such as the clown video in the figure). Assuming that the clown video does not support horizontal playback, the horizontal switching control may not be displayed. When the horizontal media content (such as the landscape video in the figure) is played, the landscape video supports horizontal playback, and the horizontal switching control 402 may be displayed. When the first user clicks the horizontal switching control 402, the first interface 401 in the vertical display mode is switched to the first interface 403 in the horizontal display mode, and the landscape video is presented in a horizontal manner in the first interface 403 in the horizontal display mode.

In some embodiments, the second display mode includes a horizontal display mode, and the second manner includes a horizontal manner. After the first media content is presented in a horizontal manner in the first interface, the method further comprises: in response to the floating display mode being triggered, the current display mode of the first interface is switched from the horizontal display mode to the floating display mode; in the first interface displayed in the form of a horizontal floating control, the first media content is continued to be presented in a horizontal manner. The advantage of such a setting is that the switching from the horizontal display mode to the floating display mode can be flexibly realized.

Exemplarily, the floating control can be a view element, and the properties of the floating control, such as shape, color, transparency, and display position, can be set according to actual needs. For example, the floating control can be a control in the form of a floating frame. A horizontal floating control can be a floating control whose control width is greater than control height. At least one border or at least two borders of the horizontal floating control coincide with the interface boundary of the preset application. For example, three borders of the horizontal floating control coincide with the interface boundary of the preset application. The way to trigger the floating display mode can be to trigger the floating switching control.

After the current display mode of the first interface is switched from the horizontal display mode to the floating display mode in response to the floating display mode being triggered, the method further comprises: displaying a preset interface. The size of the horizontal floating control is smaller than the interface size of the preset application, and the preset interface can be displayed in the preset application, and the horizontal floating control can be displayed on the upper layer of the preset interface. Among them, the preset interface can be any interface other than the first interface, such as a message interface, a video call interface or a personal media stream interface, wherein the personal media stream interface can be used to display the media stream corresponding to the first user, and the media stream corresponding to the first user can be a media stream pushed to the first user.

In some embodiments, after the current display mode of the first interface is switched from the horizontal display mode to the floating display mode in response to the floating display mode being triggered, the method further comprises: displaying the preset interface in the vertical display mode. The advantage of such a setting is that it meets the vertical viewing requirements of the user when viewing the preset interface.

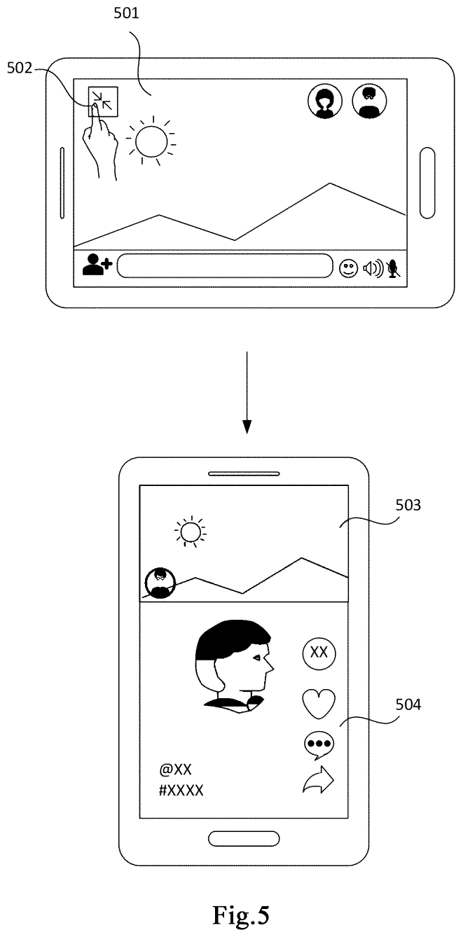

FIG. 5 is another interface interaction schematic diagram provided by the embodiment of the present disclosure. The first interface 501 is currently in the horizontal display mode. After the first user clicks the floating switch button 502, the first interface 501 switches to the floating display mode, and the first interface 503 displayed in the form of a horizontal floating control is obtained, and continue to present the landscape video in a horizontal manner. In addition, the preset interface 504 is displayed in the preset application, and the preset interface 504 can be the personal media stream interface corresponding to the first user.

In some embodiments, the second display mode includes a horizontal display mode, the second manner includes a horizontal manner, and after the first media content is displayed in the horizontal manner in the first interface, the method further comprises: in response to the second trigger operation input by the first user for the session interaction control corresponding to the shared interaction, the current display mode of the first interface is switched from the horizontal display mode to the floating display mode; the session interaction interface corresponding to the shared interaction is displayed; and continue to present the first media content in the first interface displayed in the form of a floating control. The advantage of such a setting is that in the horizontal display mode, the session interaction requirements in the shared interaction are taken into account.

The session interaction interface may include a session information viewing interface, and may also include a session information input interface, etc., in which an input control such as an input panel or a virtual keyboard may be displayed. The second trigger operation may be, for example, a click operation or a long press operation, etc.

In some embodiments, displaying of the session interaction interface corresponding to the shared interaction comprises: displaying the session interaction interface corresponding to the shared interaction in a vertical display mode; wherein, continuing to present the first media content in the first interface displayed in the form of a floating control comprises: continuing to present the first media content in a horizontal manner in the first interface displayed in the form of a horizontal floating control. The advantage of such a setting is that it meets the user's vertical interface viewing needs when performing session interaction.

In some embodiments, after the displaying of the session interaction interface corresponding to the shared interaction, the method further comprises: receiving the first session information input by the first user based on the session interaction interface. The advantage of such a setting is that it can meet the user's session information input needs.

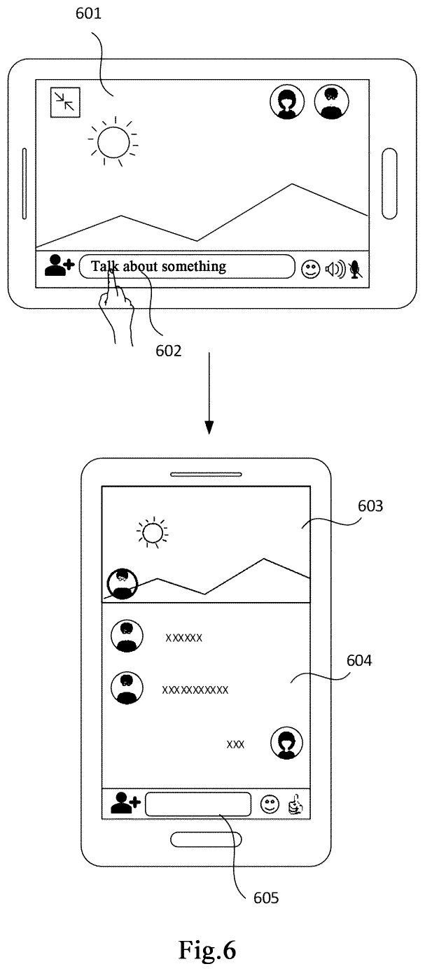

FIG. 6 is another interface interaction schematic diagram provided by an embodiment of the present disclosure. The first interface 601 is currently in a horizontal display mode. After the first user clicks the session interaction control 602, the first interface 601 switches to a floating display mode, and a first interface 603 displayed in the form of a horizontal floating control is obtained, and continue to present the landscape video in a horizontal manner. In addition, the session interaction interface 604 is displayed in the preset application, and the first user can view the session information record between himself and the second user in the shared interaction. If the first user wants to send session information, the session input control 605 can be triggered to pop up the input panel for input.

After the session interaction interface is displayed, the input control can also be automatically displayed to facilitate the first user to input the session message.

In some embodiments, the second display mode includes a horizontal display mode, and the second manner includes a horizontal manner. After the first media content is displayed in a horizontal manner in the first interface, the method further comprises: in response to the preset operation input by the first user, the first preset function is implemented on the first interface, wherein the preset operation is used to implement the second preset function when the first interface is in the vertical display mode. The advantage of this setting is that the horizontal display mode and the vertical display mode are differentiated, so that the same preset operation can implement different preset functions in different display modes.

Exemplarily, when the first interface displays the user identification of the second user, the preset operation may be a trigger operation of the user identification. In the vertical display mode, the preset operation may implement sending a conversation message to the second user corresponding to the triggered user identification. In the horizontal display mode, the preset operation may implement switching to the video call screen of the second user corresponding to the triggered user identification.

In some embodiments, the first preset function is implemented on the first interface in response to the preset operation input by the first user, comprising: in response to the preset switching operation input by the first user, switching the current display mode of the first interface from the horizontal display mode to the vertical display mode, wherein the preset switching operation is used to switch the shared media content presented on the first interface when the first interface is in the vertical display mode. The advantage of such a setting is that when the preset switching operation in the vertical display mode is input in the horizontal display mode, the vertical display mode is first switched to the vertical display mode instead of directly switching the shared media content, to avoid misoperation in the horizontal display mode.

Exemplarily, in the vertical display mode, the shared media content can be switched by sliding, such as sliding up to switch to the next shared media content and sliding down to switch to the previous shared media content. In the horizontal display mode, when the first user inputs a sliding operation, the first interface can be switched to the vertical display mode.

In some embodiments, the first media content includes a live stream in the live broadcast room, and the second display mode includes a bullet comment display mode; wherein, displaying the first media content in the first interface in a second manner includes: displaying the first media content and the bullet comment information area corresponding to the first media content in the first interface. The advantage of such a setting is that when sharing the live stream, the bullet comment information area can be displayed, so that users participating in the shared interaction can view more comprehensive live broadcast room related information

Exemplarily, the bullet comment display mode may include a vertical bullet comment display mode and a horizontal bullet comment display mode. The bullet comment information area may be an area for presenting bullet comment information. The bullet comment information may be a real-time message released by an audience user in the live broadcast room, which may also be referred to as comment information or speech information. When the first display mode is a display mode of horizontal without bullet comment, the second display mode is a display mode of horizontal bullet comment; when the first display mode is a display mode of vertical without bullet comment, the second display mode is a display mode of vertical bullet comment.

In some embodiments, after presenting the first media content and the bullet comment information area corresponding to the first media content in the first interface, the method further comprises: receiving a first target message input by the first user, wherein the first target message includes a conversation message for the participating users of the shared interaction to view; and/or, receiving a second target message input by the first user, wherein the second target message includes bullet comment information for the audience in the live broadcast room to view. The advantage of such a setting is that the first user can be allowed to input messages for different types of users to view.

The participating users of the shared interaction include the first user and the second user; the audience in the live broadcast room includes the first user, the second user, and the audience users in the live broadcast room who do not participate in the shared interaction.

The first user can use different input methods to input the first target message and the second target message, so as to clarify the viewable users of the target message to be sent. The difference between different input methods can be reflected in different input entrances, or different sending controls for confirming sending, etc.

In some embodiments, after presenting the first media content and the bullet comment information area corresponding to the first media content in the first interface, the method further comprises: in response to the bullet comment hiding operation input by the first user, canceling the presentation of the bullet comment information area. The advantage of such a setting is that the user can choose whether to hide the bullet comment information area according to their actual needs. If the bullet comment information area needs to be hidden, the bullet comment hiding operation can be input to enhance the immersiveness of live broadcast viewing.

In some embodiments, the presentation of the bullet comment information area is canceled in response to the bullet comment hiding operation input by the first user, including: in response to the third trigger operation input by the first user for the preset area in the first interface, the presentation of the bullet comment information area is canceled, wherein the preset area and the bullet comment information area do not have an intersection. The advantage of such a setting is that the convenience of hiding the bullet comment area is improved. Among them, the third trigger operation can be, for example, a click operation or a long press operation.

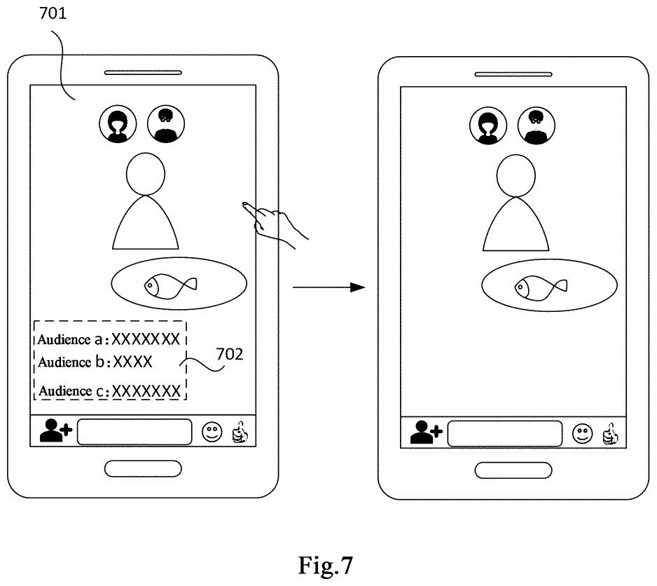

FIG. 7 is another interface interaction schematic diagram provided by an embodiment of the present disclosure. The first interface 701 is currently in a vertical display mode, and is presenting a live stream in the live broadcast room. While presenting the live stream, the bullet comment information area 702 is also displayed. Assume that after the first user clicks on the preset area outside the bullet comment information area 702, the presentation of the bullet comment information area is cancelled.

In some embodiments, after presenting the first media content and the bullet comment information area corresponding to the first media content in the first interface, the method further comprises: in response to the fourth trigger operation input by the first user for the bullet comment releasing control, displaying a preset input control in the first interface; receiving the first bullet comment information input by the first user based on the preset input control. The advantage of such a setting is that, on the basis of supporting the viewing of bullet comment information, the bullet comment information releasing function is supported to improve the interactive effect of the shared live stream.

Exemplarily, the bullet comment releasing control may be a “release bullet comment” button, etc., and the fourth trigger operation may be, for example, a click operation or a long press operation, etc. The user may trigger the display of the preset input control by clicking the bullet comment releasing control, and the preset input control may be, for example, an input panel or a virtual keyboard, etc., and input the bullet comment content that he wants to release through the preset input control.

Displaying the preset input control in the first interface comprises: switching the current display mode of the first interface from the horizontal display mode to the vertical display mode, and displaying the preset input control in the first interface in the vertical display mode.

In some embodiments, after presenting the first media content and the bullet comment information area corresponding to the first media content in the first interface, the method further comprises: in response to receiving the second bullet comment information released by the second user, displaying the second bullet comment information in the bullet comment information area in a first preset display manner, wherein the third bullet comment information in the bullet comment information area is displayed in a second preset display manner, and the third bullet comment information is released by a third user who does not participate in the shared interaction in the live broadcast room, and the first preset display manner is different from the second preset display manner. The advantage of such a setting is that the bullet comment released by ordinary viewers in the live broadcast room and the bullet comment released by users participating in the shared interaction can be displayed differently, so that the first user can quickly find the bullet comment information released by the second user, thereby improving the live broadcast shared interaction effect.

Exemplarily, the difference between the first preset display manner and the second preset display manner is not limited, for example, it may include different display positions, different display sizes, different display styles, etc., and the different styles may include different user identification, different bullet comment information fonts or colors, etc.

In some embodiments, the method further comprises: in response to the publishing operation of the first bullet comment information, displaying the first bullet comment information in the bullet comment information area in a first preset display manner. In this way, the display manner of the bullet comment information released by the first user may also be different from the display manner of the bullet comment information released by ordinary viewers.

Displaying the first bullet comment information in the bullet comment information area in a first preset display manner comprises: switching the current display mode of the first interface from the vertical display mode to the horizontal display mode, and displaying the first bullet comment information in the bullet comment information area in the first interface in the horizontal display mode in the first preset display manner.

In some embodiments, the method further comprises: in response to receiving the second session information based on the shared interaction sent by the second user, displaying the second session information in the target associated area of the user identification corresponding to the second user in the first interface, wherein the target associated area is different from the bullet comment information area. The advantage of such a setting is that the session information sent by the second user is displayed in an area associated with the user identification of the second user outside the bullet comment information area, so that the first user can effectively distinguish the bullet comment information and session information released by the second user.

In some embodiments, the method further comprises: in response to the sending operation of the first session information, in the target associated area of the user identification corresponding to the first user in the first interface, displaying the first session information.

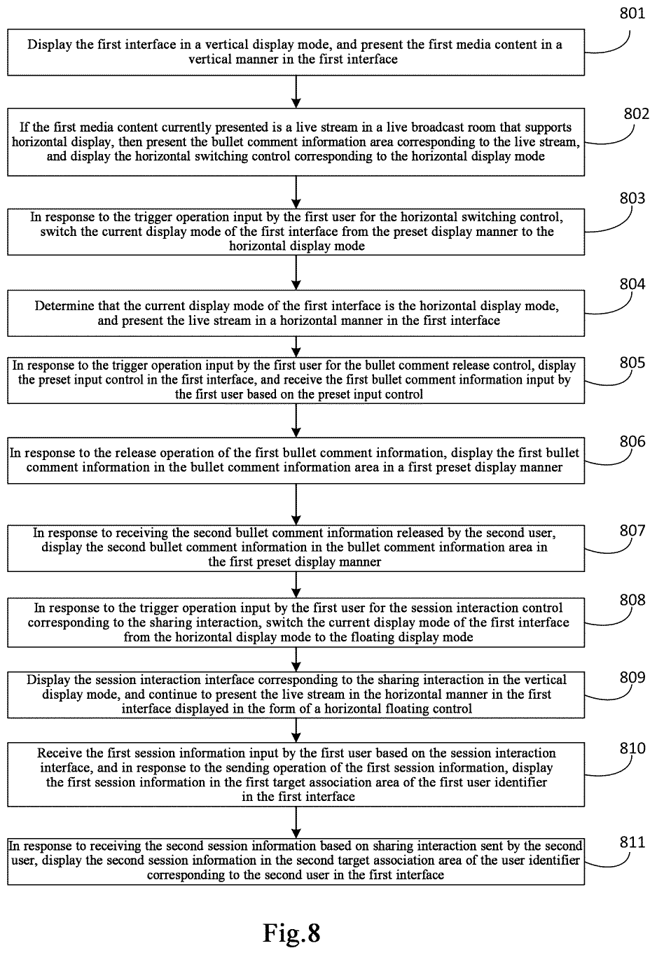

FIG. 8 is a flow chart of another content presentation method provided by the embodiment of the present disclosure. The embodiment of the present disclosure is explained based on the scheme in the above embodiment, and the method includes the following steps:

Step 801, display the first interface in a vertical display mode, and present the first media content in a vertical manner in the first interface.

The vertical display mode is the first display mode, and the vertical manner is the first manner.

Step 802, if the first media content currently presented is a live stream in a live broadcast room that supports horizontal display, then present the bullet comment information area corresponding to the live stream, and displaying the horizontal switching control corresponding to the horizontal display mode.

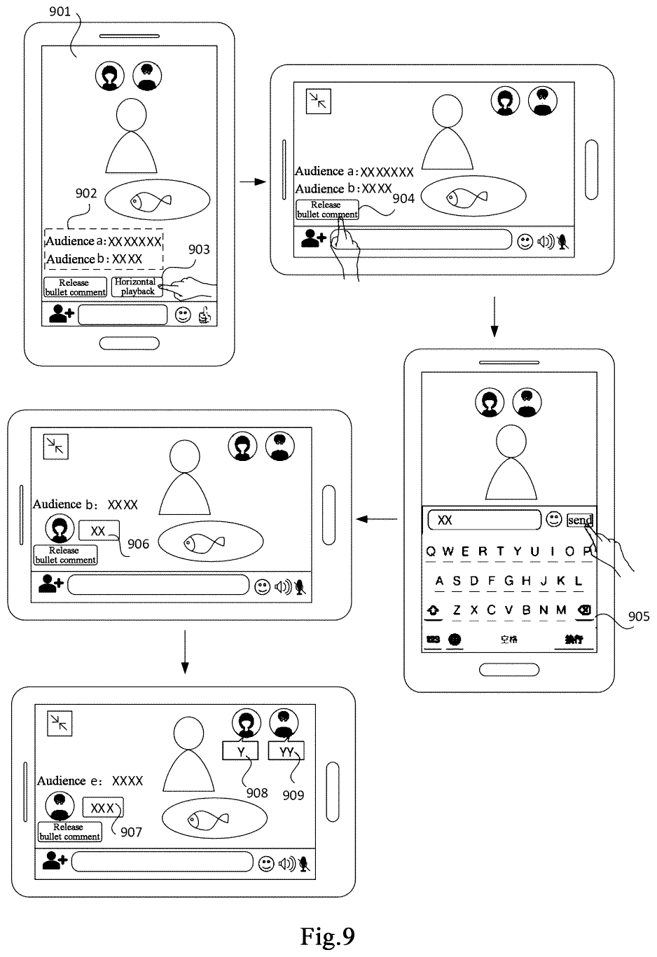

Exemplarily, FIG. 9 is another interface interaction schematic diagram provided by the embodiment of the present disclosure. As shown in FIG. 9, the live stream is presented in the first interface 901 in the vertical display mode, and the bullet comment information area 902 corresponding to the live stream is presented. If the live stream supports horizontal presentation, then the horizontal switching control 903 corresponding to the horizontal display mode is displayed. In addition, the user identifications of the users participating in the shared interaction, such as the avatars of the first user and the second user, can also be displayed in the first interface.

Step 803: in response to the trigger operation input by the first user for the horizontal switching control, switch the current display mode of the first interface from the preset display mode to the horizontal display mode.

As shown in FIG. 9, when the first user clicks the horizontal switching control 903, the first interface switches to the horizontal display mode.

Step 804: determine that the current display mode of the first interface is the horizontal display mode, and present the live stream in a horizontal manner in the first interface.

The horizontal display mode is the second display mode, and the horizontal manner is the second manner.

As shown in FIG. 9, after determining that the first interface has switched to the current horizontal display mode, the live stream is presented in a horizontal manner in the first interface, and the bullet comment information area continues to be displayed in the first interface.

Step 805: in response to the trigger operation input by the first user for the bullet comment release control, display the preset input control in the first interface, and receive the first bullet comment information input by the first user based on the preset input control.

As shown in FIG. 9, after the first user clicks the bullet comment release control 904, in order to facilitate the user to input bullet comment information, the first interface can be switched to a vertical display mode and a preset input control 905 can be displayed. The preset input control can also be displayed while maintaining the horizontal display mode of the first interface. The first bullet comment information input by the first user is received based on the preset input control 905, such as “XX” in the figure.

Step 806, in response to the release operation of the first bullet comment information, display the first bullet comment information in the bullet comment information area in a first preset display manner.

The second preset display manner of the third bullet comment information released by the third user in the live broadcast room in the bullet comment information area is different from the first preset display manner.

As shown in FIG. 9, when the first user clicks the send button, it is considered that the release operation of the first bullet comment information is received, and the first bullet comment information 906 is displayed in the bullet comment information area in the first preset display manner. Compared with the third bullet comment information sent by viewer b, the first bullet comment information 906 correspondingly displays the first user's avatar, and the first bullet comment information is displayed with a border, so that the first user can quickly find the bullet comment information he has released. In the first interface on the second user side, the display mode of the first bullet comment information is also the first preset display manner.

Step 807: in response to receiving the second bullet comment information released by the second user, display the second bullet comment information in the bullet comment information area in the first preset display manner.

As shown in FIG. 9, if the second bullet comment information released by the second user is received, the second bullet comment information 907 is displayed in the bullet comment information area in the first preset display manner, that is, the avatar of the second user is displayed correspondingly, and the second bullet comment information is displayed with a border, so that the first user can quickly find the bullet comment information released by the second user.

Step 808: in response to the trigger operation input by the first user for the session interaction control corresponding to the shared interaction, switch the current display mode of the first interface from the horizontal display mode to the floating display mode.

Step 809: display the session interaction interface corresponding to the shared interaction in the vertical display mode, and continue to present the live stream in the horizontal manner in the first interface displayed in the form of a horizontal floating control.

Step 810: receive the first session information input by the first user based on the session interaction interface, and in response to the sending operation of the first session information, display the first session information in the first target associated area of the first user identification in the first interface.

The interface interaction mode for the first user to input the first session information is similar to FIG. 6, and FIG. 6 can be referred to. The first user identification is the user identification corresponding to the first user, and the first target associated area is different from the bullet comment message area. As shown in FIG. 9, the first session information 908 is displayed in the form of a bubble below the first user identification.

Step 811, in response to receiving the second session information based on shared interaction sent by the second user, display the second session information in the second target associated area of the user identification corresponding to the second user in the first interface.

The second user identification is the user identification corresponding to the second user, and the second target associated area is different from the bullet comment message area. As shown in FIG. 9, the second session information 909 is displayed in the form of a bubble below the second user identification. The first user can view the bullet comment message information and session information sent by the second user in the bullet comment message area and the second target associated area of the second user identification, respectively.

The content presentation method provided by the disclosed embodiment can display bullet comment information at the same time when the shared interaction of the media stream is carried out, if the current display is the live stream in the live broadcast room, so that the user can view more comprehensive information related to the live broadcast room, and provide a trigger control for the horizontal display mode when the live stream supports horizontal presentation, so that the horizontal display mode can be conveniently switched to watch the shared live stream. In the process of watching the shared live stream, the user can also release bullet comment information, and the bullet comment information released by the user participating in the shared interaction is displayed differently from the bullet comment information of the general audience, so as to facilitate the search. In addition, the session interaction function is retained, and the session message is displayed outside the bullet comment information area, so that the user can distinguish between the bullet comment information and the session information.

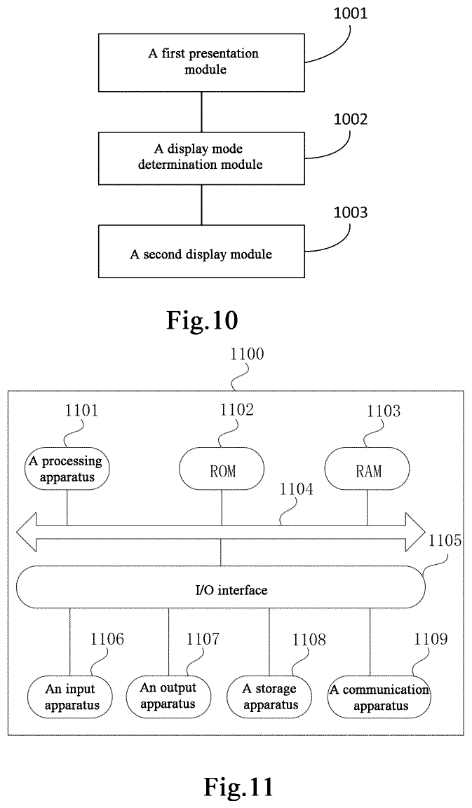

FIG. 10 is a schematic diagram of the structure of a content presentation apparatus provided by an embodiment of the present disclosure. As shown in FIG. 10, the apparatus comprises:

a first presentation module 1001, configured to display a first interface in a first display mode and display first media content in a first manner in the first interface, wherein the first interface is used to present shared media content in a shared media stream, and the shared media stream includes a media stream corresponding to a shared interaction performed between a first user and at least one second user; a display mode determination module 1002, configured to determine that the current display mode of the first interface is a second display mode, wherein the second display mode is different from the first display mode; a second presentation module 1003, configured to present the first media content in a second manner in the first interface, wherein the second manner is different from the first manner.

The content presentation apparatus provided by an embodiment of the present disclosure displays a first interface in a first display mode and displays first media content in a first manner in the first interface, wherein the first interface is used to present shared media content in a shared media stream, and the shared media stream includes a media stream corresponding to a shared interaction performed between a first user and at least one second user, determines that the current display mode of the first interface is a second display mode, and presents the first media content in a second manner in the first interface. By adopting the above technical solution, during the shared interaction process of the first user with the second user's based on the shared media stream, the first interface for presenting the shared media content has the ability to switch the display mode, so that the first user can view the shared media content presented in different ways, enriching the presentation form of the shared media content.

The second display mode includes a horizontal display mode, and the second manner includes a horizontal manner. The apparatus also comprises:
a first switching module, configured to switch the current display mode of the first interface from the first display mode to the horizontal display mode in response to the horizontal display mode being triggered before determining that the current display mode of the first interface is the horizontal display mode.

The first switching module comprises:
a switching control display unit, configured to display the horizontal switching control corresponding to the horizontal display mode if the first media content is a preset type of media content, wherein the preset type of media content supports horizontal presentation; a first switching unit, configured to switch the current display mode of the first interface from the first display mode to the horizontal display mode in response to the first trigger operation input by the first user for the horizontal switching control.

The second display mode includes a horizontal display mode, the second manner includes a horizontal mode, and the apparatus further comprises:
a second switching module, configured to switch the current display mode of the first interface from the horizontal display mode to the floating display mode in response to the floating display mode being triggered after the first media content is displayed in the horizontal manner in the first interface; a first float display module, configured to continue to present the first media content in the horizontal manner in the first interface displayed in the form of a horizontal float control.

The apparatus further comprises:
a preset interface display module, configured to display a preset interface in the vertical display mode after the current display mode of the first interface is switched from the horizontal display mode to the floating display mode in response to the floating display mode being triggered.

The second display mode includes a horizontal display mode, the second manner includes a horizontal manner, and the apparatus further comprises:
a third switching module, configured to switch the current display mode of the first interface from the horizontal display mode to the floating display mode in response to the second trigger operation input by the first user for the session interaction control corresponding to the shared interaction after displaying the first media content in the horizontal manner in the first interface; an interactive interface display module, configured to display the session interaction interface corresponding to the shared interaction; a second floating display module, configured to continue to present the first media content in the first interface displayed in the form of a floating control.

The interactive interface display module is configured to display the session interaction interface corresponding to the shared interaction in the vertical display mode; wherein the second floating display module is configured to continue to present the first media content in the horizontal manner in the first interface displayed in the form of a horizontal floating control.

The apparatus further comprises:
a first session information receiving module, configured to after displaying the session interaction interface corresponding to the shared interaction, further include: receive the first session information input by the first user based on the session interaction interface.

The second display mode includes a horizontal display mode, the second manner includes a horizontal manner, and the apparatus further comprises:
a preset function implementation module, configured to implement a first preset function on the first interface in response to a preset operation input by the first user after displaying the first media content in a horizontal manner on the first interface, wherein the preset operation is used to implement a second preset function when the first interface is in a vertical display mode.

The preset function implementation module is configured to:
switch the current display mode of the first interface from the horizontal display mode to the vertical display mode in response to a preset switching operation input by the first user, wherein the preset switching operation is used to switch the shared media content presented on the first interface when the first interface is in a vertical display mode.

The first media content includes a live stream in a live broadcast room, and the second display mode includes a bullet comment display mode; wherein the second presentation module is configured to:
present the first media content and the bullet comment information area corresponding to the first media content on the first interface.

The apparatus also includes a first receiving module and/or a second receiving module:
the first receiving module is configured to receive a first target message input by the first user after presenting the first media content and the bullet comment information area corresponding to the first media content in the first interface, wherein the first target message includes a session message for the participating users of the shared interaction to view; the second receiving module is configured to receive a second target message input by the first user after presenting the first media content and the bullet comment information area corresponding to the first media content in the first interface, wherein the second target message includes bullet comment information for the audience in the live broadcast room to view.

The apparatus also comprises:
a bullet comment cancellation presentation module, configured to cancel the presentation of the bullet comment information area in response to a bullet comment hiding operation input by the first user after presenting the first media content and the bullet comment information area corresponding to the first media content in the first interface.

The bullet comment cancellation presentation module is configured to:
in response to a third trigger operation input by the first user for a preset area in the first interface, cancel the presentation of the bullet comment information area, wherein the preset area does not have an intersection with the bullet comment information area.

The apparatus also comprises:
an input control display module, configured to display a preset input control in the first interface present in response to the fourth trigger operation input by the first user for the bullet comment release control, after presenting the first media content and the bullet comment information area corresponding to the first media content in the first interface; a first bullet comment information receiving module, configured to receive the first bullet comment information input by the first user based on the preset input control.

The apparatus also comprises:
a second bullet comment information display module, configured to display the second bullet comment information in the bullet comment information area in a first preset display manner, after presenting the first media content and the bullet comment information area corresponding to the first media content in the first interface, and in response to receiving the second bullet comment information released by the second user, wherein the third bullet comment information in the bullet comment information area is displayed in a second preset display manner, and the third bullet comment information is released by a third user who does not participate in the shared interaction in the live broadcast room, and the first preset display manner is different from the second preset display manner.

The apparatus also comprises:
a second session information display module, configured to display the second session information in a target associated area of a user identification corresponding to the second user in the first interface in response to receiving the second session information based on the shared interaction sent by the second user, wherein the target associated area is different from the bullet comment information area.

The content presentation apparatus provided in the embodiment of the present disclosure can execute the content presentation method provided in any embodiment of the present disclosure, and has the corresponding functional modules and effects of the execution method.

The multiple units and modules included in the above-mentioned apparatus are only divided according to functional logic, but are not limited to the above-mentioned division, as long as the corresponding functions can be realized; in addition, the names of the multiple functional units are only for the convenience of distinguishing each other, and are not used to limit the protection scope of the embodiment of the present disclosure.

FIG. 11 is a structural schematic diagram of an electronic device provided by the embodiment of the present disclosure. Referring to FIG. 11 below, it shows a structural schematic diagram of an electronic device (such as a terminal device or server in FIG. 11) 1100 suitable for implementing the embodiment of the present disclosure. The terminal device in the embodiment of the present disclosure may include mobile terminals such as mobile phones, laptops, digital broadcast receivers, personal digital assistants (Personal Digital Assistant, PDA), tablet computers (Portable Android Device, PAD), portable multimedia players (Portable Media Player, PMP), vehicle terminals (such as vehicle navigation terminals), etc., and fixed terminals such as digital televisions (Television, TV), desktop computers, etc. The electronic device 1100 shown in FIG. 11 is only an example and should not bring any limitations to the functions and scope of use of the embodiment of the present disclosure.

As shown in FIG. 11, the electronic device 1100 may include a processing apparatus (e.g., a central processing unit, a graphics processing unit, etc.) 1101, which can perform various appropriate actions and processes according to a program stored in a read-only memory (ROM) 1102 or a program loaded from a storage apparatus 1108 to a random access memory (RAM) 1103. In the RAM 1103, various programs and data required for the operation of the electronic device 1100 are also stored. The processing apparatus 1101, the ROM 1102, and the RAM 1103 are connected to each other via a bus 1104. An input/output (I/O) interface 1105 is also connected to the bus 1104.

Typically, the following apparatus may be connected to the I/O interface 1105: input apparatus 1106 including, for example, a touch screen, a touchpad, a keyboard, a mouse, a camera, a microphone, an accelerometer, a gyroscope, etc. ; output apparatus 1107 including, for example, a liquid crystal display (LCD), a speaker, a vibrator, etc. ; storage apparatus 1108 including, for example, a tape, a hard disk, etc. ; and communication apparatus 1109. The communication apparatus 1109 may allow the electronic device 1100 to communicate wirelessly or wired with other devices to exchange data. Although FIG. 11 shows an electronic device 1100 having a variety of apparatus, it is not required to implement or have all of the apparatus shown. More or fewer apparatus may be implemented or have alternatively.

According to an embodiment of the present disclosure, the process described above with reference to the flowchart may be implemented as a computer software program. For example, an embodiment of the present disclosure includes a computer program product including a computer program carried on a non-transitory computer-readable medium, the computer program including a program code for executing the method shown in the flowchart. In such an embodiment, the computer program can be downloaded and installed from the network through the communication apparatus 1109, or installed from the storage apparatus 1108, or installed from the ROM 1102. When the computer program is executed by the processing apparatus 1101, the above functions defined in the method of the embodiment of the present disclosure are executed.

The names of the messages or information exchanged between the multiple apparatus in the embodiment of the present disclosure are only for illustrative purposes, and are not used to limit the scope of these messages or information.

The electronic device provided by the embodiment of the present disclosure belongs to the same concept as the content presentation method provided by the above embodiment. The technical details not described in detail in this embodiment can be referred to the above embodiment, and this embodiment has the same effect as the above embodiment.

The embodiment of the present disclosure provides a computer storage medium, on which a computer program is stored, and the program implements the content presentation method provided by the above embodiment when executed by the processor.

The above-mentioned computer-readable medium of the present disclosure can be a computer-readable signal medium or a computer-readable storage medium or any combination of the above two. The computer-readable storage medium can be, for example, an electrical, magnetic, optical, electromagnetic, infrared, or semiconductor system, device or device, or any combination of the above. Examples of computer-readable storage media may include: an electrical connection with one or more conductors, a portable computer disk, a hard disk, RAM, ROM, an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in combination with an instruction execution system, device or device. In the present disclosure, a computer-readable signal medium may include a data signal propagated in a baseband or as part of a carrier wave, which carries a computer-readable program code. Such propagated data signals may take a variety of forms, including electromagnetic signals, optical signals, or any suitable combination of the above. A computer-readable signal medium may also be any computer-readable medium other than a computer-readable storage medium, which may send, propagate, or transmit a program for use by or in combination with an instruction execution system, device, or device. The program code contained on the computer-readable medium can be transmitted using any appropriate medium, including: wires, optical cables, radio frequencies (RF), etc., or any suitable combination of the above.

In some implementations, the client and the server can communicate using any currently known or future developed network protocol such as HyperText Transfer Protocol (HTTP), and can be interconnected with any form or medium of digital data communication (e.g., communication network). Examples of communication networks include local area networks (LAN), wide area networks (WAN), internets (e.g., the Internet), and peer-to-peer networks (e.g., ad hoc peer-to-peer networks), as well as any currently known or future developed networks.

The above computer-readable medium can be contained in the above electronic device; it can also exist separately without being assembled into the electronic device.

The computer-readable medium carries one or more programs. When the one or more programs are executed by the electronic device, causing the electronic device to: display a first interface in a first display mode, and present the first media content in the first interface in a first manner, wherein the first interface is used to present the shared media content in a shared media stream, and the shared media stream includes a media stream corresponding to the shared interaction performed between the first user and at least one second user; determine that the current display mode of the first interface is a second display mode, wherein the second display mode is different from the first display mode; present the first media content in the first interface in a second manner, wherein the second manner is different from the first manner.

The computer program code for performing the operations of the present disclosure can be written in one or more programming languages or a combination thereof, and the programming languages include object-oriented programming languages—such as Java, Smalltalk, C++, and conventional procedural programming languages—such as “C” language or similar programming languages. The program code can be executed entirely on the user's computer, partially on the user's computer, as an independent software package, partially on the user's computer and partially on a remote computer, or entirely on a remote computer or server. In cases involving remote computers, the remote computer may be connected to the user computer through any type of network, including a LAN or WAN, or may be connected to an external computer (e.g., through the Internet using an Internet service provider).

The flowcharts and block diagrams in the accompanying drawings illustrate the possible architecture, functions, and operations of the systems, methods, and computer program products according to various embodiments of the present disclosure. In this regard, each box in the flowchart or block diagram may represent a module, a program segment, or a portion of a code, which contains one or more executable instructions for implementing the specified logical functions. It should also be noted that in some alternative implementations, the functions marked in the box may also occur in a different order than that marked in the accompanying drawings. For example, two boxes represented in succession may actually be executed substantially in parallel, and they may sometimes be executed in reverse order, depending on the functions involved. It should also be noted that each box in the block diagram and/or flowchart, and the combination of boxes in the block diagram and/or flowchart, may be implemented with a dedicated hardware-based system that performs the specified functions or operations, or may be implemented with a combination of dedicated hardware and computer instructions.

The units involved in the embodiments described in the present disclosure may be implemented by software or by hardware. In one case, the name of the module does not constitute a limitation on the module itself. For example, the second display module may also be described as “a module for displaying the first media content in the first interface in a second manner, wherein the second manner is different from the first manner”.

The functions described above in this article may be at least partially performed by one or more hardware logic components. For example, without limitation, exemplary types of hardware logic components that may be used include: Field Programmable Gate Array (FPGA), Application Specific Integrated Circuit (ASIC), Application Specific Standard Parts (ASSP), System on Chip (SOC), Complex Programming Logic Device (CPLD), etc.

In the context of the present disclosure, a machine-readable medium may be a tangible medium that may contain or store a program for use by or in conjunction with an instruction execution system, device or equipment. A machine-readable medium may be a machine-readable signal medium or a machine-readable storage medium. Machine-readable media may include electronic, magnetic, optical, electromagnetic, infrared, or semiconductor systems, devices or equipment, or any suitable combination of the above. Examples of machine-readable storage media may include electrical connections based on one or more lines, portable computer disks, hard disks, RAM, ROM, EPROM or flash memory, optical fibers, CD-ROMs, optical storage devices, magnetic storage devices, or any suitable combination of the above.

According to one or more embodiments of the present disclosure, a content presentation method is provided, comprising:
displaying a first interface in a first display mode, and presenting first media content in a first manner in the first interface, wherein the first interface is used to present shared media content in a shared media stream, and the shared media stream includes a media stream corresponding to a shared interaction performed between a first user and at least one second user;
determining that the current display mode of the first interface is a second display mode, wherein the second display mode is different from the first display mode;
presenting the first media content in a second manner in the first interface, wherein the second manner is different from the first manner.

According to one or more embodiments of the present disclosure, the second display mode includes a horizontal display mode, the second manner includes a horizontal manner, and before determining that the current display mode of the first interface is the horizontal display mode, the method further comprises:
in response to the horizontal display mode being triggered, switching the current display mode of the first interface from the first display mode to the horizontal display mode.

According to one or more embodiments of the present disclosure, in response to the horizontal display mode being triggered, switching the current display mode of the first interface from the first display mode to the horizontal display mode, including:
in response to the first media content being a preset type of media content, displaying the horizontal switching control corresponding to the horizontal display mode, wherein the preset type of media content supports horizontal presentation;
in response to the first trigger operation input by the first user for the horizontal switching control, the current display mode of the first interface is switched from the first display mode to the horizontal display mode.

According to one or more embodiments of the present disclosure, the second display mode includes a horizontal display mode, the second manner includes a horizontal manner, and after displaying the first media content in a horizontal manner in the first interface, the method further comprises:
in response to the floating display mode being triggered, switching the current display mode of the first interface from the horizontal display mode to the floating display mode;
in the first interface displayed in the form of a horizontal floating control, continuing to present the first media content in the horizontal manner.

According to one or more embodiments of the present disclosure, after in response to the floating display mode being triggered, switching the current display mode of the first interface from the horizontal display mode to the floating display mode, the method further comprises:
displaying a preset interface in a vertical display mode.

According to one or more embodiments of the present disclosure, the second display mode includes a horizontal display mode, the second manner includes a horizontal manner, and after presenting the first media content in the horizontal manner in the first interface, the method further comprises:
in response to the second trigger operation input by the first user for the session interaction control corresponding to the shared interaction, switching the current display mode of the first interface from the horizontal display mode to the floating display mode;
displaying the session interaction interface corresponding to the shared interaction;
continuing to display the first media content in the first interface displayed in the form of a floating control.

According to one or more embodiments of the present disclosure, displaying the session interaction interface corresponding to the shared interaction comprises:
displaying the session interaction interface corresponding to the shared interaction in a vertical display mode;
wherein continuing to present the first media content in the first interface displayed in the form of a floating control comprises:
continuing to present the first media content in a horizontal manner in the first interface displayed in the form of a horizontal floating control.

According to one or more embodiments of the present disclosure, after displaying the session interaction interface corresponding to the shared interaction, the method further comprises:
receiving the first session information input by the first user based on the session interaction interface.

According to one or more embodiments of the present disclosure, the second display mode comprises a horizontal display mode, the second manner includes a horizontal manner, and after presenting the first media content in a horizontal manner in the first interface, the method further comprises:
in response to a preset operation input by the first user, implementing a first preset function on the first interface, wherein the preset operation is used to implement a second preset function in a case that the first interface is in a vertical display mode.

According to one or more embodiments of the present disclosure, in response to the preset operation input by the first user, implementing the first preset function on the first interface comprises:
in response to a preset switching operation input by the first user, switching the current display mode of the first interface from the horizontal display mode to the vertical display mode, wherein the preset switching operation is used to switch the shared media content presented on the first interface in a case that the first interface is in a vertical display mode.

According to one or more embodiments of the present disclosure, the first media content includes a live stream in a live broadcast room, and the second display mode includes a bullet comment display mode;
wherein, presenting the first media content in the first interface in a second manner comprises:
presenting the first media content and the bullet comment information area corresponding to the first media content in the first interface.

According to one or more embodiments of the present disclosure, after presenting the first media content and the bullet comment information area corresponding to the first media content in the first interface in the first interface, the method further comprises:
receiving a first target message input by the first user, wherein the first target message includes a conversation message for the participating users of the shared interaction to view; and/or receiving a second target message input by the first user, wherein the second target message includes bullet comment information for the audience in the live broadcast room to view.

According to one or more embodiments of the present disclosure, after presenting the first media content and the bullet comment information area corresponding to the first media content in the first interface, the method further comprises:
in response to the bullet comment hiding operation input by the first user, canceling the presentation of the bullet comment information area.

According to one or more embodiments of the present disclosure, in response to bullet comment hiding operation input by the first user, canceling the presentation of the bullet comment information area comprises:
in response to a third trigger operation input by the first user for a preset area in the first interface, canceling the presentation of the bullet comment information area, wherein the preset area and the bullet comment information area do not have an intersection.

According to one or more embodiments of the present disclosure, after presenting the first media content and the bullet comment information area corresponding to the first media content in the first interface, the method further comprises:
in response to a fourth trigger operation input by the first user for a bullet comment release control, displaying a preset input control in the first interface;
receiving the first bullet comment information input by the first user based on the preset input control.

According to one or more embodiments of the present disclosure, after presenting the first media content and the bullet comment information area corresponding to the first media content in the first interface, the method further comprises:
in response to receiving the second bullet comment information released by the second user, displaying the second bullet comment information in the bullet comment information area in a first preset display manner, wherein the third bullet comment information in the bullet comment information area is displayed in a second preset display manner, and the third bullet comment information is released by a third user in the live broadcast room who does not participate in the shared interaction, and the first preset display manner is different from the second preset display manner.

According to one or more embodiments of the present disclosure, the method further comprises:
in response to receiving the second session information based on the shared interaction sent by the second user, displaying the second session information in the target associated area of the user identification corresponding to the second user in the first interface, wherein the target associated area is different from the bullet comment information area.

According to one or more embodiments of the present disclosure, a content presentation apparatus is provided, comprising:
a first presentation module, configured to present a first interface in a first display mode, and to display first media content in a first manner in the first interface, wherein the first interface is used to present shared media content in a shared media stream, and the shared media stream includes a media stream corresponding to a shared interaction performed between a first user and at least one second user;
a display mode determination module, configured to determine that the current display mode of the first interface is a second display mode, wherein the second display mode is different from the first display mode;
a second presentation module, configured to present the first media content in a second manner in the first interface, wherein the second manner is different from the first manner.

According to one or more embodiments of the present disclosure, an electronic device is provided, the electronic device comprising:
one or more processors;
a storage apparatus, configured to store one or more programs;
when the one or more programs are executed by the one or more processors, the one or more processors implement the content presentation method provided by the embodiment of the present disclosure.

According to one or more embodiments of the present disclosure, a storage medium containing computer executable instructions is provided, wherein the computer executable instructions are used to execute the content presentation method provided by the embodiment of the present disclosure when executed by a computer processor.

According to one or more embodiments of the present disclosure, a computer program product is provided, including a computer program carried on a non-transitory computer-readable medium, wherein the computer program contains program code for executing a content presentation method provided by an embodiment of the present disclosure.

In addition, although multiple operations are depicted in a specific order, this should not be understood as requiring these operations to be performed in the specific order shown or in a sequential order. In certain environments, multitasking and parallel processing may be advantageous. Similarly, although multiple implementation details are included in the above discussion, these should not be interpreted as limiting the scope of the present disclosure. Some features described in the context of separate embodiments can also be implemented in combination in a single embodiment. Conversely, multiple features described in the context of a single embodiment can also be implemented in multiple embodiments individually or in any suitable sub-combination.

1. A content presentation method, comprising:
displaying a first interface in a first display mode, and presenting first media content in a first manner in the first interface, wherein the first interface is configured to present shared media content in a shared media stream, and the shared media stream includes a media stream corresponding to shared interaction performed between a first user and at least one second user;
determining that a current display mode of the first interface is a second display mode, wherein the second display mode is different from the first display mode; and
presenting the first media content in a second manner in the first interface, wherein the second manner is different from the first manner.

2. The method according to claim 1, wherein the second display mode includes a horizontal display mode, the second manner includes a horizontal manner, and before determining that the current display mode of the first interface is the horizontal display mode, the method further comprises:
in response to the horizontal display mode being triggered, switching the current display mode of the first interface from the first display mode to the horizontal display mode.

3. The method according to claim 2, wherein in response to the horizontal display mode being triggered, switching the current display mode of the first interface from the first display mode to the horizontal display mode, comprises:
in response to the first media content being a preset type of media content, displaying a horizontal screen switching control corresponding to the horizontal display mode, wherein the preset type of media content supports horizontal presentation; and
in response to a first trigger operation input by the first user for the horizontal screen switching control, switching the current display mode of the first interface from the first display mode to the horizontal display mode.

4. The method according to claim 1, wherein the second display mode includes a horizontal display mode, the second manner includes a horizontal manner, and after presenting the first media content in the horizontal manner in the first interface, the method further comprises:
in response to a floating display mode being triggered, switching the current display mode of the first interface from the horizontal display mode to the floating display mode; and
in the first interface displayed in a form of a horizontal floating control, continuing to present the first media content in the horizontal manner.

5. The method according to claim 4, after in response to the floating display mode being triggered, switching the current display mode of the first interface from the horizontal display mode to the floating display mode, the method further comprises:
displaying a preset interface in a vertical display mode.

6. The method according to claim 1, wherein the second display mode includes a horizontal display mode, the second manner includes a horizontal manner, and after presenting the first media content in the horizontal manner in the first interface, the method further comprises:
in response to a second trigger operation input by the first user for a session interaction control corresponding to the shared interaction, switching the current display mode of the first interface from the horizontal display mode to a floating display mode;
displaying a session interaction interface corresponding to the shared interaction;
continuing to present the first media content in the first interface displayed in a form of a floating control.

7. The method according to claim 6, wherein displaying the session interaction interface corresponding to the shared interaction comprises:
displaying a session interaction interface corresponding to the shared interaction in a vertical display mode; and
wherein continuing to present the first media content in the first interface displayed in the form of the floating control comprises:
continuing to present the first media content in the horizontal manner in the first interface displayed in a form of a horizontal floating control.

8. The method according to claim 6, after displaying the session interaction interface corresponding to the shared interaction, the method further comprises:
receiving first session information input by the first user based on the session interaction interface.

9. The method according to claim 1, wherein the second display mode comprises a horizontal display mode, the second manner comprises a horizontal manner, and after presenting the first media content in the horizontal manner in the first interface, the method further comprises:
in response to a preset operation input by the first user, implementing a first preset function on the first interface, wherein the preset operation is configured to implement a second preset function in a case that the first interface is in a vertical display mode.

10. The method according to claim 9, wherein in response to the preset operation input by the first user, implementing the first preset function on the first interface includes:
in response to a preset switching operation input by the first user, switching the current display mode of the first interface from the horizontal display mode to the vertical display mode, wherein the preset switching operation is configured to switch shared media content presented on the first interface in a case that the first interface is in the vertical display mode.

11. The method according to claim 1, wherein the first media content comprises a live stream in a live broadcast room, and the second display mode comprises a bullet comment display mode;
wherein presenting the first media content in the first interface in the second manner comprises:
presenting the first media content and bullet comment information area corresponding to the first media content in the first interface.

12. The method according to claim 11, after presenting the first media content and the bullet comment information area corresponding to the first media content in the first interface, the method further comprises at least one of the following:
receiving a first target message input by the first user, wherein the first target message includes a conversation message for a participating user of the shared interaction to view; and
receiving a second target message input by the first user, wherein the second target message includes bullet comment information for audience in the live broadcast room to view.

13. The method according to claim 11, after presenting the first media content and the bullet comment information area corresponding to the first media content in the first interface, the method further comprises:
in response to a bullet comment hiding operation input by the first user, canceling a presentation of the bullet comment information area.

14. The method according to claim 13, wherein in response to the bullet comment hiding operation input by the first user, canceling the presentation of the bullet comment information area comprises:
in response to a third trigger operation input by the first user for a preset area in the first interface, canceling the presentation of the bullet comment information area, wherein the preset area and the bullet comment information area do not have an intersection.

15. The method according to claim 11, after presenting the first media content and the bullet comment information area corresponding to the first media content in the first interface, the method further comprises:
in response to a fourth trigger operation input by the first user for a bullet comment release control, displaying a preset input control in the first interface; and
receiving first bullet comment information input by the first user based on the preset input control.

16. The method according to claim 11, after presenting the first media content and the bullet comment information area corresponding to the first media content in the first interface, the method further comprises:
in response to receiving second bullet comment information released by the second user, displaying the second bullet comment information in the bullet comment information area in a first preset display manner, wherein a third bullet comment information in the bullet comment information area is displayed in a second preset display manner, the third bullet comment information is released by a third user in the live broadcast room who does not participate in the shared interaction, and the first preset display manner is different from the second preset display manner.

17. The method according to claim 11, further comprises:
in response to receiving second session information based on the shared interaction sent by the second user, displaying the second session information in a target associated area of a user identification corresponding to the second user in the first interface, wherein the target associated area is different from the bullet comment information area.

18. (canceled)

19. (canceled)

20. An electronic device, comprising:
at least one processor; and
a storage apparatus, configured to store at least one program;
wherein the at least one program, when executed by the at least one processor, causes the at least one processor to:
display a first interface in a first display mode, and present first media content in a first manner in the first interface, wherein the first interface is configured to present shared media content in a shared media stream, and the shared media stream includes a media stream corresponding to shared interaction performed between a first user and at least one second user;
determine that a current display mode of the first interface is a second display mode, wherein the second display mode is different from the first display mode; and
present the first media content in a second manner in the first interface, wherein the second manner is different from the first manner.

21. A non-transitory storage medium comprising computer executable instructions, wherein the computer executable instructions, when executed by a computer processor, are configured to:
display a first interface in a first display mode, and present first media content in a first manner in the first interface, wherein the first interface is configured to present shared media content in a shared media stream, and the shared media stream includes a media stream corresponding to shared interaction performed between a first user and at least one second user;
determine that a current display mode of the first interface is a second display mode, wherein the second display mode is different from the first display mode; and
present the first media content in a second manner in the first interface, wherein the second manner is different from the first manner.

22. (canceled)

23. The electronic device according to claim 20, wherein the second display mode includes a horizontal display mode, the second manner includes a horizontal manner, and before determining that the current display mode of the first interface is the horizontal display mode, the at least one program further causing the at least one processor to:
switch the current display mode of the first interface from the first display mode to the horizontal display mode in response to the horizontal display mode being triggered.
